(19) United States
(12) Patent Application Publication
(10) Pub. No.: US 2017/0009023 A1
(43) Pub. Date: Jan. 12, 2017

(54) PROCESS FOR THE PROCESSING OF AN UNDRIED, PARTICULATE POLYMER OR POLYMER MIXTURE BY MEANS OF A SINGLE- OR MULTISCREW EXTRUDER

(71) Applicant: LEISTRITZ EXTRUSIONSTECHNIK GMBH, Nurnberg (DE)

(72) Inventor: Dieter RATH, Schwabach (DE)

(21) Appl. No.: 15/201,818

(22) Filed: Jul. 5, 2016

(30) Foreign Application Priority Data
Jul. 7, 2015 (DE) 10 2015 110 983.2

(51) Int. Cl. C08J 3/00; B29B 13/06

(52) U.S. Cl. CPC C08J 3/00; B29B 13/065; B29B 2013/002

(57) ABSTRACT

A process for the processing of an undried particulate polymer or polymer mixture by means of a single- or multiscrew extruder comprising a barrel comprising one or more screws, a feed section intended for the polymer and provided on the barrel and, provided on the barrel, a melting region in which the polymer or polymer mixture melts, where the undried polymer or polymer mixture introduced by way of the feed section into the barrel is devolatilized in at least one vacuum devolatilization region downstream of the feed section and upstream of the melting region in the barrel.

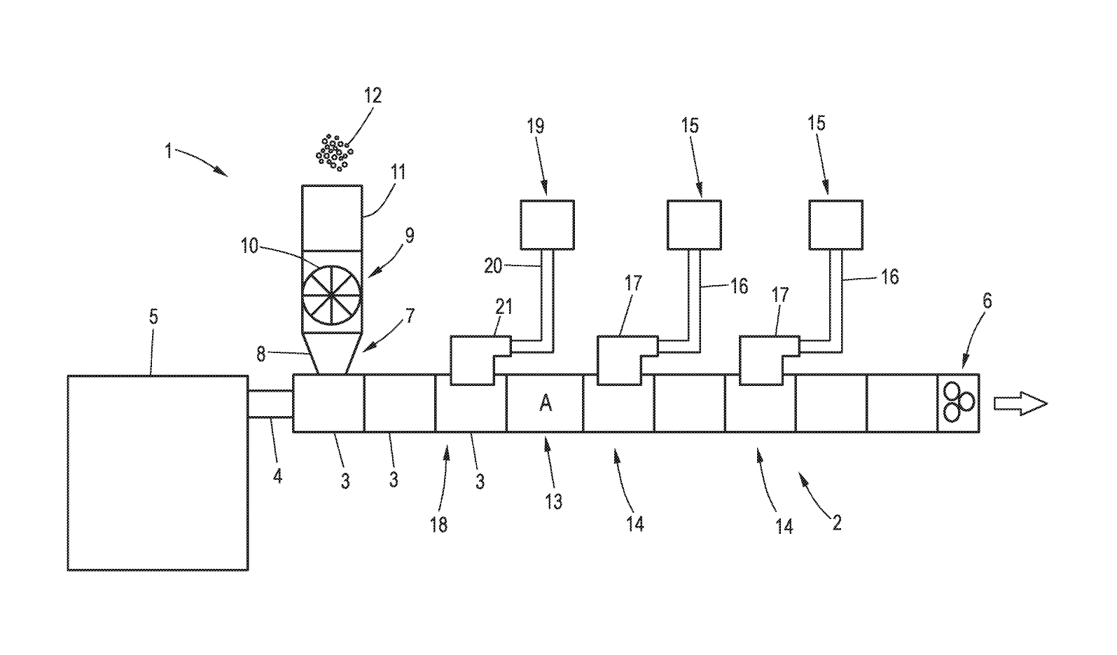

### CROSS-REFERENCE TO RELATED APPLICATIONS

The present application claims priority of DE 10 2015 110 983.2, filed Jul. 7, 2015, the priority of this application is hereby claimed and this application is incorporated herein by reference.

### BACKGROUND OF THE INVENTION

The invention relates to a process for the processing of an undried particulate polymer or polymer mixture by means of a single- or multiscrew extruder comprising a barrel comprising one or more screws, a feed section intended for the polymer and provided on the barrel and, provided on the barrel, a melting region in which the polymer melts.

is Particulate polymers or polymer mixtures are generally processed by means of extruders to give pellets, films or other intermediate or final products. The term “polymer” will be exclusively used hereinafter, but that term embraces not only a single type of polymer but also polymer mixtures. The polymer in the form of free-flowing solid is processed or treated by means of a single- or multiscrew extruder comprising a barrel comprising one or more screws, with the aim of converting the said polymer to the desired intermediate or final product form in a shaping process directly downstream of the extruder. The polymer is introduced into the barrel by way of a feed section of the barrel, and is transported by way of the one or more screws rotating therein. It passes into a melting region in which it melts in such a way that a homogeneous melt is formed which is transported as far as the end of the barrel where by way of example it is transferred to an ancillary device serving to shape the product.

Polymers processed sometimes comprise water resulting from hygroscopic properties or from upstream washing processes. Some polymers are susceptible to hydrolytic degradation during melting and during processing in the melt phase; the extent of said degradation is approximately proportional to the quantity of water present.

This molecular degradation of the polymer impairs the properties of the product. Examples of known hygroscopic plastics which can be susceptible to hydrolytic degradation during processing are polyethylene terephthalate (PET), polylactides (PLA), polyamides (PA), polycarbonates (PC) and polybutylene terephthalate (PBT), but this list is not exclusive.

In a known method of avoiding this molecular degradation, the polymer is dried by way of a drying apparatus before introduction into the barrel, i.e. the polymer is predried by using an external drying apparatus upstream of the feed section. This type of drying apparatus is a large-volume and in particular expensive device with high energy consumption. Processing moreover requires a separate pretreatment step, namely predrying.

### SUMMARY OF THE INVENTION

The problem underlying the invention is to provide a process which can process an undried particulate polymer without any significant hydrolytic degradation of the polymer during extruder processing.

According to the invention, this problem is solved in a process of the type mentioned in the introduction in that the undried polymer introduced by way of the feed section into the barrel is devolatilized in at least one vacuum devolatilization region downstream of the feed section and upstream of the melting region in the barrel.

The process of the invention permits processing of undried polymer without the risk of an impermissible high level of hydrolytic degradation, because according to the invention the undried polymer introduced into the barrel is devolatilized in a vacuum devolatilization region downstream of the feed section and upstream of the melting section. The polymer is dried by way of the said vacuum devolatilization, i.e. a considerable portion, preferably almost 100%, of the residual moisture present is removed. This is achieved through application of a vacuum, where this in principle means a pressure lower than atmospheric pressure. The pressure generated in the vacuum devolatilization region or by way of corresponding vacuum-generation equipment is preferably at least 500 mbar, or preferably less. It should be in the range from 500 mbar to 5 mbar, but it is also likewise possible to apply lower pressures, for example extending to 0.1 mbar.

The polymer devolatilized, i.e. dried, in the devolatilization region is then conveyed into the melting region, where it melts as described, but does not undergo any significant extent of hydrolytic decomposition, i.e. the effect on polymer degradation is from substantial reduction to almost complete suppression.

The polymer is preferably introduced into the feed section by way of a valve. The design of the said valve is such that it permits generation and maintenance of the vacuum in the devolatilization region, i.e. it is vacuum-tight to the extent that the desired reduced pressure can be obtained. For this purpose, it is preferable to use a rotary valve or a plurality of rotary valves installed in series behind one another. This rotary valve comprises an impeller wheel rotatably mounted in an annular chamber onto which the polymer is usually input from above. There is a very small distance between the moving vanes of the wheel and the annular cavity wall and by way of this and by way of the polymer applied it is possible to achieve a substantial degree of sealing. At an outlet on the underside, the polymer then passes into the feed region of the extruder.

According to an advantageous embodiment, it is possible to introduce air which flows from the barrel as far as the vacuum devolatilization region. This produces a small air current which is advantageous for removal of the residual moisture present. The air flowing through the system serves, as it were, as transport medium which entrains the water molecules, which are loosely bound, and conveys the same out of the barrel by way of the vacuum volatilization region. The air introduced is likewise removed by way of the vacuum devolatilization region, and it is therefore possible to exclude any resultant introduction of moisture into the polymer to be processed.

According to a first embodiment of the invention, this defined air flow can enter the barrel by way of the valve, by way of the rotary valve, for example. As described above, this valve or rotary valve can achieve sufficient sealing to permit generation of the relatively small vacuum, but of course does not achieve complete sealing. This means that a defined introduction of air can be achieved by way of the valve, if necessary by appropriate design adjustment.

As an alternative to introduction of air by way of the valve, it is possible to provide separate air-introduction equipment on the barrel, i.e. a type of introduction nozzle which is by way of example opened by a pressure-reduction-control system by way of a valve, or which can have an assigned corresponding on-off valve controlled by way of control equipment. This method again can ensure that a small amount of air flows into the system.

In a third alternative in the invention, air is allowed to flow into the barrel by way of the inlet region of the one or more screws. In the region where the one or more screws enter the barrel, they are sealed, or mounted, by way of appropriate sealing elements. The design of this sealing region, which again in view of the small pressure reduction does not have to be completely gas-tight, can then be such as to permit flow of an appropriately defined quantity of air into the barrel.

The overall effect of the process of the invention is that a hygroscopic polymer can be processed reliably and in particular in a manner that reduces hydrolytic degradation, because the vacuum devolatilization region permits removal of volatile substances that would lead to that type of degradation, these generally of course being water, and the polymer is dried in situ in the barrel directly before the actual melting procedure. The longer the residence time in the vacuum devolatilization region, the greater the degree of drying.

The invention provides not only the actual process but also an extruder which in particular serves for carrying out the process of the type described, comprising a barrel comprising one or more screws, a feed section intended for the polymer and provided on the barrel and, provided on the barrel, a melting region in which the polymer melts. This extruder features, provided downstream of the feed section and upstream of the melting region in the barrel, at least one vacuum devolatilization region with assigned vacuum-generation equipment.

The extruder comprises the vacuum devolatilization region, which according to the invention is downstream of the feed section and upstream of the melting region. Assigned to the said vacuum devolatilization region there is corresponding vacuum-generation equipment comprising a pump, which can either be flanged directly onto the barrel or attached by way of an appropriate line to an appropriate connection spigot on the barrel. The barrel itself is composed in a manner known per se of a plurality of barrel segments arranged in series behind one another and connected to one another, and it is therefore possible to form the vacuum devolatilization region by integrating, into the series of barrel segments, one or more appropriate barrel segments with an appropriate connector spigot for the pump or the devolatilization hose.

The design of the vacuum-generation equipment is such that a pressure smaller than atmospheric pressure, in particular in the range from 500 to 0.1 mbar (absolute pressure), i.e. an adequate pressure reduction in comparison with atmospheric pressure, can be generated in the vacuum devolatilization region.

Metering equipment is provided for the introduction of the polymer particles being processed; this equipment permits introduction of a defined quantity of the polymer.

Between the said metering equipment and the feed section, which usually comprises an input hopper, according to the invention there is a valve arranged permitting generation of vacuum in the vacuum devolatilization region and designed in such a way that it is sufficiently leakproof to provide the desired reduced pressure that is to be achieved. It is preferable to use a rotary valve for this purpose, but it is also possible to use other types of valve here.

The design of this valve can be such that by way of the same it is possible for a defined quantity of air to flow into the system and pass through the barrel as far as the vacuum devolatilization region. This means that when the polymer is introduced into the barrel a certain quantity of air is concomitantly introduced, and in turn is discharged by way of the vacuum system. An appropriate air flow is thus provided which assists evaporation of the volatile substances which are to be discharged and which would be responsible for hydrolytic degradation, generally of course water.

Another possibility, instead of a small quantity of air flowing in the system by way of the valve, is provision on the barrel of equipment to introduce the air which passes through the barrel as far as the devolatilization region, for example in the form of a nozzle with assigned valve which opens when an appropriate reduced pressure has been reached, or with an assigned on-off valve controllable by way of control equipment, or the like.

Finally, the flow of air into the system can be rendered possible by way of one or more sealing elements by way of which, in the inlet region, the one or more screws have been sealed with respect to the cylinder segment at that location in the barrel. Appropriate sealing of the one or more screws with respect to the barrel is necessary with a view to the reduced pressure that is to be generated. If the intention is that no air is to flow into the system by way of this seal the latter should be sufficiently leakproof, but it does not have to be completely leakproof. It is possible to design the level of sealing here in such a way that it allows adequate flow of air into the barrel.

Because, according to the invention, a valve is provided and also, of course, appropriate sealing elements should be provided in the inlet region for the one or more screws, it is possible to allow air to flow into the system by way of both channels, thus providing an adequate total air flow.

The various features of novelty which characterize the invention are pointed out with particularity in the claims annexed to and forming a part of the disclosure. For a better understanding of the invention, its operating advantages, specific objects attained by its use, reference should be had to the is drawings and descriptive matter in which there are illustrated and described preferred embodiments of the invention.

### BRIEF DESCRIPTION OF THE DRAWING

In the drawing:

The single FIGURE is a schematic representation of the extruder of the invention.

### DETAILED DESCRIPTION OF THE INVENTION

The FIGURE shows an extruder 1 of the invention, suitable for carrying out the process of the invention. The extruder comprises a barrel 2 composed of a series of separate barrel segments 3 arranged in series behind one another. The barrel 2 comprises one or more screws 4 coupled to drive equipment 5. The one or more screws 5 rotate in the barrel 2 and thus transport a polymer, which has been input and which is to be melted and/or processed, as far as a discharge point 6 at the end of the barrel 2, which is optionally followed by other equipment in which the melted polymer is further processed to form an intermediate product, as depicted by the arrow at the right-hand end of the barrel 2.

The barrel 2 comprises a feed section 7, formed by the first barrel segment shown on the left-hand side of the FIGURE. The feed section 7 comprises a feed hopper 8. Arranged thereon, or upstream thereof, there is a valve 9 which in the example shown is a rotary valve 10 (or optionally a plurality of rotary valves 10, arranged in series). Upstream of the rotary valve 10 there is in turn metering equipment 11 into which the particulate polymer 12 to be processed is introduced and by way of which the said polymer is introduced with precise metering into the valve 9.

The barrel 2 moreover comprises a melting region 13 (indicated by “A”), which is formed by way of a barrel segment 3 in the example shown. However, it can also, if required by its length, be formed by way of two or more barrel segments 3 arranged in sequence. The polymer melts mainly as a result of kneading by the screws, i.e. as a result of power dissipated from the drive. The barrel segment, or the respective barrel segments, can moreover be heatable, so that it is also possible to introduce an appropriate quantity of heat into the polymer by way of the barrel segment(s), so that the said polymer melts in this melting region 13.

The melted polymer is then transported onwards by way of the one or more screws 4. Downstream of the melting region 13 there are two vacuum devolatilization regions 14, in each case formed by an appropriate barrel segment 3 to which appropriate vacuum-generation equipment 15 has been assigned, usually appropriate pumps which in the example shown are attached by way of appropriate hose connections 16 at appropriate connection flanges 17 of the barrel segments 3. By way of these vacuum devolatilization regions 14 it is possible to achieve vacuum devolatilization, i.e. removal, from the barrel 2 of volatile constituents that form as a result of melting of the polymer 12, and of residual moisture that is present, with the result that the polymer discharged at the end of the barrel is very substantially or almost completely devolatilized.

According to the invention, there is a vacuum devolatilization region 18 provided between the feed section 7 and the melting region 13, i.e. downstream of the feed region 7 and upstream of the melting region 13. Its location is preferably directly before the melting region 13, i.e. before the, or the first, barrel segment whose temperature is appropriately controlled for melting. The vacuum devolatilization region 18 is formed by way of a barrel segment 3 or a plurality of barrel segments 3 connected by way of an appropriate hoseline or pipeline 20, attached to a connection flange 21 of the barrel segment 3, to appropriate vacuum-generation equipment 19, which in turn takes the form of, or comprises, an appropriate pump. By way of the vacuum-generation equipment it is possible to generate a pressure in a range that is preferably from 500 to 5 mbar; this means that an appropriate pressure reduced in comparison with atmospheric pressure is generated in the vacuum devolatilization region 18, in particular of course in the direction of the feed section 7, while in the other direction, i.e. towards the melting region 13, the barrel is sealed by the melted polymer.

By way of this vacuum devolatilization and the vacuum devolatilization region 18 it is possible to remove evaporating substances, in particular water, residual moisture, to a large extent from the barrel; this therefore means that the polymer 12, which was input in undried form, is dried during actual processing, before melting. This method therefore permits in-situ drying of the polymer 12, which was introduced in undried form. Because evaporating substances and residual moisture are removed, hydrolytic degradation of the polymer which can otherwise take place in the melting region 13 is reduced or occurs only to a negligible extent which has no effect of any kind on the quality of the intermediate product to be produced.

Generation of the desired reduced pressure in the vacuum devolatilization region 18 or in the barrel section between the feed section 7 or the valve 9 and of the melting region 13 requires appropriate sealing of the one or more screws 4 in the region of entering into the barrel 2, and this is achieved by way of appropriate sealing elements which seal the screw(s) with respect to the barrel segment. There is no need for absolute gas-impermeability here, because the pressure reduction to be generated is relatively small. The valve 9 and, respectively, rotary valve 10 should also be sufficiently vacuum-tight to permit generation of the desired reduced pressure.

It is nevertheless advantageous that a small quantity of air flows into the barrel 2 by way of the valve 9 or by way of the shaft seal, or optionally by way of both. This flow of air into the system serves, as it were, as transport medium to entrain the evaporating substances, i.e. mainly water, along the barrel and to transport the same to the vacuum devolatilization region 18, where the air flowing into the system is discharged together with the volatile substances transported. The nature of the air flow and, respectively, of the design of the valve 9 and of the shaft seal should be such that the air flow does not impair generation of the reduced pressure, i.e. that the level of reduced pressure to be achieved can be generated without difficulty, and that air flow velocity is not excessive, the aim here being that input polymer, in particular if its bulk density is very low, is not entrained by the air flow and discharged at the vacuum devolatilization region. Because discharge of a few polymer particles by way of the vacuum devolatilization region cannot be entirely excluded by virtue of the vacuum applied, it is advantageous to use vacuum-generation equipment 19 with assigned solids separator which can by way of example be arranged in the connection hose 20.

While specific embodiments of the invention have been shown and described in detail to illustrate the inventive principles, it will be understood that the invention may be embodied otherwise without departing from such principles.

We claim:

1. A process for the processing of an undried particulate polymer or polymer mixture by means of a single- or multiscrew extruder comprising a barrel comprising one or more screws, a feed section intended for the polymer and provided on the barrel and, provided on the barrel, a melting region in which the polymer or polymer mixture melts, wherein the undried polymer or polymer mixture introduced by way of the feed section into the barrel is devolatilized in at least one vacuum devolatilization region downstream of the feed section and upstream of the melting region in the barrel.

2. The process according to claim 1, wherein the prevailing pressure in the vacuum devolatilization region is in the range from 500 to 10-1 mbar.

3. The process according to claim 1, wherein the polymer or polymer mixture is introduced into the feed section by way of a valve.

4. The process according to claim 3, wherein the polymer or polymer mixture is introduced by way of one or more rotary valves.

5. The process according to claim 1, wherein air is introduced and flows from the barrel as far as the vacuum devolatilization region.

6. The process according to claim 5, wherein the air flows into the barrel by way of the valve, by way of introduction equipment provided on the barrel or by way of the region where the one or more screws enter(s) the barrel.

7. An extruder, in particular for the conduct of the process according to claim 1, comprising a barrel comprising one or more screws, a feed section intended for the particulate polymer or polymer mixture and provided on the barrel and, provided on the barrel, a melting region in which the polymer or polymer mixture melts, wherein there is, provided downstream of the feed section and upstream of the melting region in the barrel, at least one vacuum devolatilization region with assigned vacuum-generation equipment.

8. The extruder according to claim 7, wherein by way of the vacuum-generation equipment it is possible to generate a pressure in the range from 500 to 0.1 mbar in the vacuum devolatilization region.

9. The extruder according to claim 7, wherein arranged between metering equipment that introduces the polymer to be processed and the feed section, there is a valve arranged permitting generation of vacuum in the vacuum devolatilization region.

10. The extruder according to claim 9, wherein the valve is a rotary valve or a combination of a plurality of rotary valves.

11. The extruder according to claim 9, wherein the design of the valve is such that by way of the same air flows into the system and passes through the barrel as far as the vacuum devolatilization region.

12. The extruder according to claim 7, wherein, provided on the barrel, there is introduction equipment for air, by way of which air flows into the system and passes through the barrel as far as the vacuum devolatilization region.

13. The extruder according to claim 7, wherein in the region where the one or more screws enter the barrel they have been sealed by way of one or more sealing elements.

14. The extruder according to claim 13, wherein the design of the sealing elements is such that air flows into the system and passes through the barrel as far as the vacuum devolatilization region.
